(19) United States
(12) Patent Application Publication
(10) Pub. No.: US 2002/0184183 A1
(43) Pub. Date: Dec. 5, 2002

(54) Personalized media service

(76) Inventors: Darrel D. Cherry, Meridian, ID (US); Garth F. Schmeling, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/872,116

(22) Filed: Jun. 1, 2001

(51) Int. Cl. G06F 7/00

(52) U.S. Cl. 707/1

(57) ABSTRACT

A personalized media service is provided wherein a user may select a media request from a list of available media for printing as a hardcopy. The media request may be customized in accordance with specified user preferences such that a content provider may provide the user with a tailored media experience.

### FIELD OF THE INVENTION

This invention involves the creation of media on demand in response to the preferences of a user. More particularly, this invention involves the compilation of electronic information and the printing of a media hardcopy based upon the selection of specific electronic information by a user.

### BACKGROUND OF THE INVENTION

Millions of people read media such as newspapers, magazines, and journals on a daily basis. Typically, the media is delivered to a home, a place of business, or a library. As computers and internet access become more prevalent, users are also beginning to read electronic media more frequently. Even with the proliferation of electronic media, however, many people prefer to read or browse hardcopies of their favorite media.

Many people have hardcopies of their favorite media delivered directly to their home or place of business on a periodic schedule. Newspapers are often delivered daily, and magazines typically arrive on a weekly or monthly basis. Other individuals purchase the media at local stores or newsstands. Many times, however, the local store or newsstand may not have the desired media in stock. Furthermore, if the media is obscure and not read by many individuals, it is unlikely that the local store or newsstand will even carry the desired media. For example, a person living in the United States who desires a foreign magazine or newspaper may have a very hard time obtaining the desired media, especially if the individual lives in a rural location. Although the individual may be able to order a subscription to the media, delivery is often times delayed by days, if not weeks, due to the expenses involved with delivering media overseas. Thus, by the time the individual receives the desired media, much of the information may be outdated or no longer interesting to the purchaser.

In an attempt to provide more individuals timely access to media, many newspapers, magazines and journals are now available over the internet. An internet user may subscribe and access an electronic version of their favorite media for a fee. Those individuals subscribing to an internet subscription who prefer hardcopies must print out each article on a printer. Often times, printing the entire media on the printer of a home computer system is tedious and uses much more paper than the hardcopy counterpart sold by the media producer. For those individuals who prefer hardcopies of media, the availability of internet subscriptions or electronic copies of the desired media is not a favorable option.

Furthermore, hardcopies of media sold over-the-counter, or on a subscription basis, are not customizable. The ability of the media supplier to customize its articles to the particular customer is limited at best, and often times non-existent. In other words, a media copy sold in New York City will be the same as that sold in rural Nebraska. Although some media suppliers offer different versions, or local versions, of their media product, the customization is limited to a large target audience, usually in the neighborhood of thousands of individuals.

It would be desirable, therefore, to provide a media service from which an individual could obtain a hardcopy of a desired media from a central location, whether the media was a common media or uncommon media. Furthermore, it would be desirable to provide a method by which the media providers could tailor the media to the particular interests of the individual purchasing the desire media.

### SUMMARY OF THE INVENTION

The present invention provides consumers with the ability to obtain media “on demand.” Consumers use the personalized media service to obtain hardcopies of the media they desire from any location utilizing the present invention. The consumer selects the desired media and the personalized media service prints and binds the media while the consumer waits. The personalized media service provides consumers with the ability to obtain media from all over the world at a personalized media service in their hometown or from the convenience of their own home.

In one embodiment of the present invention, a consumer, or user, interacts with a media selection interface. The media selection interface is the “front end” of the personalized media service and facilitates interaction between a user and the personalized media service. The media selection interface presents the user with numerous media selection options. A user may scroll through the media selection options or perform a search to determine if a particular media selection is available through the personalized media service. The user chooses a particular media selection to purchase. Before printing and binding the media selection, the media selection interface queries the user for the necessary funds to purchase the media selection. The user deposits the necessary funds to complete the media request. The media selection interface queries a service provider with the media request. The service provider is typically a computer including databases and links to content providers, which provide electronic copies of the media offered by the personalized media service. Based upon the media request, the service provider determines the appropriate content provider to query for an electronic file of the media request and queries that content provider. Once the electronic file of the media request is obtained, the service provider transfers it to the media selection interface. The media selection interface manipulates the electronic file and prints and binds a hardcopy of the media request for the user.

In another embodiment of the present invention, a user logs-in to the personalized media service to activate the media selection portion of the personalized media service. Two types of log-ins exist: unregistered log-ins and pre-registered log-ins. In an unregistered log-in, an unregistered user is prompted by the media selection interface to register with the personalized media service by entering specific user information. By providing the requisite information the user becomes registered. Once the user is registered, the user is provided with an identification and password allowing them to bypass the registration step in the future and log-in as a pre-registered user. A pre-registered log-in typically involves providing a registered identification and password or swiping a magnetic stripe card through a magnetic stripe card reader associated with the media selection interface of the personalized media service. For example, a user may pre-register with a personalized media service through the mail, by phone, over the internet, or by any such method where the personalized media service may obtain information about the user. Once the requisite information is obtained, the personalized media service provides the user with an identification and password for logging-in to designated personalized media services. Alternatively, the personalized media service provides the user with an identification card, such as a credit card type magnetic stripe card or a smart card, and a personal information number allowing the user to log-in to personalized media services having identification card readers. Other available identification and log-in methods can also be used as known in the art.

In yet another embodiment of the present invention, a user creates a media request through a remote selection interface such as the internet. Like a media selection interface, the remote selection interface queries the user for their log-in information. Once a log-in is verified, the remote selection interface displays the available media selections from which the user may choose. In addition, the remote selection interface provides the user with an option for delivery of the media request, such as by mail, by express delivery, or for pickup at a specified location. For example, a user in a remote location, miles from the nearest media selection interface may use the internet to create a media request. Logging-in to an internet site for the personalized media service, the user is able to perform the same functions that they could perform at the media selection interface. If the user knows that they will be passing by the nearest media selection interface the next day, they can request that their media request be available for pick-up at that media selection interface the next day. Alternatively, the user may choose to have the media request sent to them, by mail or other delivery, so that the user would not need to travel. The media request is transmitted by the remote selection interface to either a media selection interface or directly to a service provider, where it is processed in the same fashion as described above.

The personalized media service described herein provides a user the ability to obtain media from around the world “on demand.” User's will no longer be concerned about missing out on a publication, or be worried about not being able to find a hard-to-get magazine in their local grocery store. Similarly, retailers will not be burdened with losses resulting from over-stocking, or poor sales. Nor will users need to worry about the difficulties associated with obtaining out-of-date media because electronic copies of past media issues are readily available for “on demand” printing. Furthermore, users are able to tailor their media selections to their interests by providing demographic information, which content providers use to provide more information about the topics of interest to the user.

### DESCRIPTION OF THE DRAWINGS

While the specification concludes with claims particularly pointing out and distinctly claiming that which is regarded as the present invention, the present invention can be more readily ascertained from the following description of the invention when read in conjunction with the accompanying drawings in which:

FIG. 1 illustrates a block diagram of one embodiment of the personalized media service of the present invention;

FIG. 2 illustrates a block diagram of one embodiment of the service provider of the present invention;

FIG. 3 illustrates a block diagram of one embodiment of the media selection interface of the present invention; and

FIG. 4 illustrates a block diagram of one embodiment of a display device of the present invention.

### DETAILED DESCRIPTION OF THE INVENTION

The present invention involves the creation of media on demand in response to a user's preferences. More particularly, this invention involves the compilation of electronic information and the printing of a media hardcopy based upon the electronic information received. Using the present invention, a user may obtain a hardcopy of a desired media such as a magazine, newspaper, journal, or the like, and the desired media may be tailored to the user's preferences.

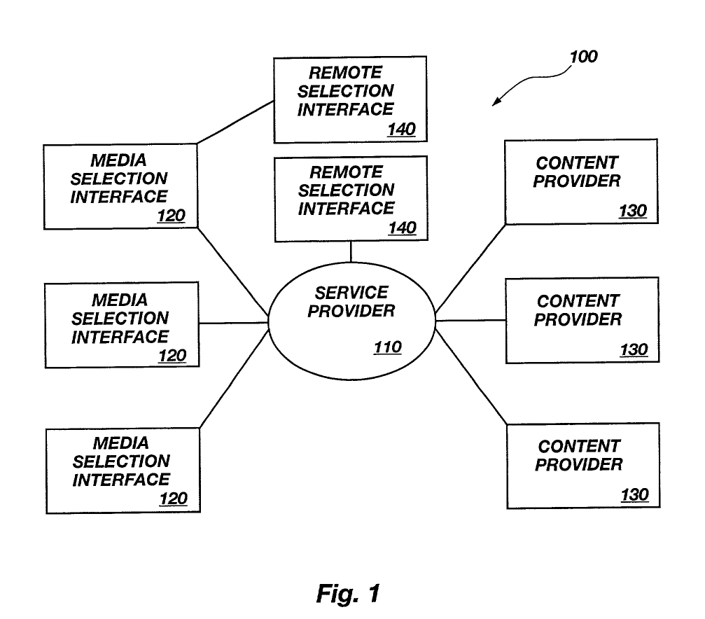

Using the present invention, a user desiring to obtain media hardcopy, such as a newspaper, magazine, short story, or otherwise, selects the desired media using a dynamic media selection interface. The user must have an established account, create an account, or pay for the desired media selection at the time the desired media selection is made. The media selection interface queries a service provider to obtain the requested media. The desired media is printed by the media selection interface and delivered to the user. In this general fashion, a user is able to obtain the desired media in the time it takes to compile and convert the electronic form of the media selection to hardcopy. The concept is relatively simple and novel, and the method and components used to carry out the present invention are further explained with reference to drawing FIGS. 1 through 4 and specific examples set forth herein.

A block diagram of one example of a personalized media service 100 of the present invention is illustrated in drawing FIG. 1. The personalized media service 100 comprises a service provider 110 in communication with a plurality of content providers 130, a plurality of media selection interfaces 120, and, optionally, at least one remote selection interface 140. A user desiring to obtain a hardcopy of a selected media from the personalized media service 100 selects the desired media using either a media selection interface 120 or a remote selection interface 140. For example, a user selects a magazine from options displayed by a media selection interface 120. The media selection interface 120 queries the service provider 110 for the selected magazine. The service provider 110 queries the appropriate content provider 130 to retrieve an electronic copy of the selected magazine. The service provider 110 communicates the electronic copy of the selected magazine to the media selection interface 120. Based upon the information received, the media selection interface 120 prints and binds the selected magazine while the user waits.

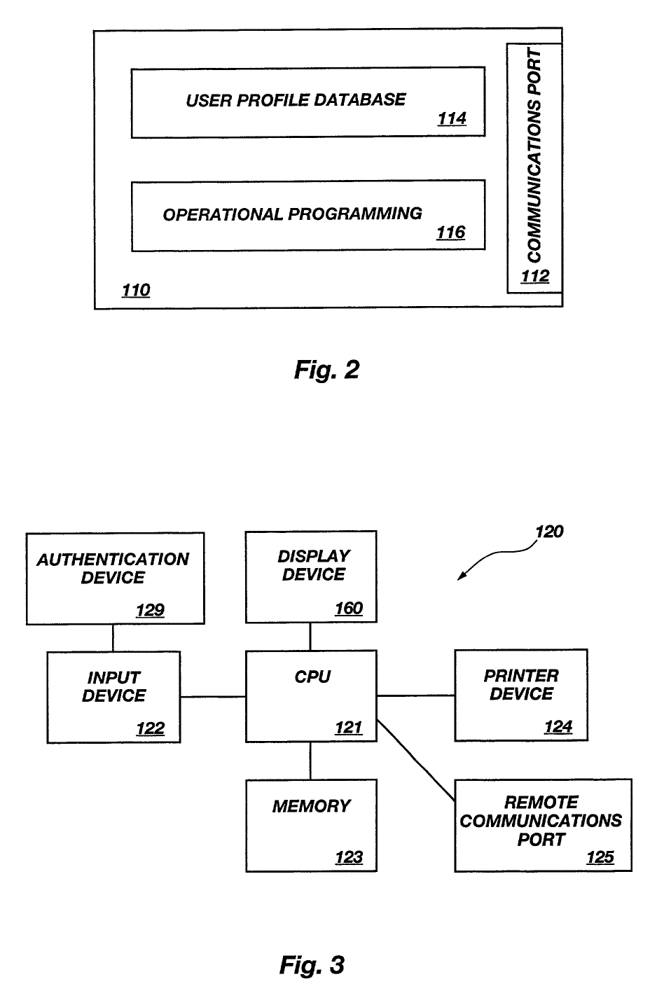

Typically, the service provider 110 is a computer system or network, including standard input, output, and processing capabilities as known in the art. The service provider 110 communicates with the content providers 130, media selection interfaces 120, and remote selection interfaces 140 via at least one communications port 112 as illustrated in drawing FIG. 2. The communications ports 112 may include any one of a modem, cable, satellite link, internet connection, infrared connection, radio frequency transmission, or other communication method well known in the art of data communications. The service provider 110 also includes at least one user profile database 114 for storing user data. Operational programming 116 or software functions, such as executable commands, stored within or accessed by the service provider 110 query the necessary content providers 130 and compile the data received by the content providers 130 for transmission to a desired media selection interface 120.

A user profile database 114 stored by a service provider 110 may include demographic information about a user, including, but not limited to, data such as gender, age, hobbies, interests, income, profession, education, marital status, vehicles owned, sports played, consumer goods owned, services used, and the like. Payment information may also be stored in a user profile database 114, such that when a user selects a desired media for delivery, the service provider 110 collects the necessary fees from the user from the information contained in the user profile database 114. For example, upon the user's selection of a desired media from a media selection interface 120, authorization is passed to the service provider 110 to debit the user's credit card for the cost of the service. The service provider 110 accesses credit card information for the particular user from a user profile database 114, and debits the user's credit card account. In another example, the user profile database 114 contains the billing information of the user. Records of a user's purchases using the personalized media service 100 are associated with the user and stored in a user profile database 114. At the end of a specified time period, such as monthly, quarterly, yearly, or the like, the service provider 110 accesses the user profile database 114 and bills the user based upon the billing and purchase information stored in the user profile database 114.

Content providers 130 are linked to the service provider 110 via data communications as known in the art. Typically, the content provider 130 is a computer system operated by a media production business, such as a magazine publisher. The content provider 130 provides the service provider 110 with an electronic copy of media published by the content provider 130 at the service provider's 110 request. After the content provider 130 provides the service provider 110 with an electronic copy of the media request, the service provider 110 may credit an account for the content provider 130 to compensate the content provider 130 for the distributed media.

A media selection interface 120 allows a user to interact with the personalized media service 100. Media selection interfaces 120 may take many forms, but typically include input and output devices, at least one central processing unit (CPU), and a printing device for creating the desire media. The media selection interface 120 may be an automated unit or may be controlled by an operator capable of using and maintaining the media selection interface 120. Media selection interfaces 120 are typically located in commercialized areas frequented by consumers desiring to purchase media through a personalized media service 100. This includes areas such as shopping malls, grocery stores, bookstores, copy centers, and the like.

Illustrated in drawing FIG. 3 is a block diagram of the components of a typical media selection interface 120. The illustrated media selection interface 120 includes a central processing unit (CPU) 121, an input device 122, a memory 123, a printer device 124, a remote communications port 125, and a display device 160. An optional authentication device 129 is also illustrated. The CPU 121 may include a computer or series of computers capable of processing data and performing operational functions with the data. The input device 122 may include a mouse, a keyboard, a pen, joystick, or other device capable of allowing a user to communicate or transmit data to the CPU 121. The optional authentication device 129 communicates with the CPU 121 through the input device 122 or through a direct connection with the CPU 121 (not shown). Authentication devices 129 include any device used to validate the identity of a user utilizing the media selection interface 120. This includes personal identification numbers, metallic stripe readers, card readers, smart card devices, biometric sensors and the like. The memory 123 is one of any type commonly used with computers and data storage and processing as known in the art. The printer device 124 is capable of printing hardcopies of the media selected by the user in the form of a normal media publication. The remote communication port 125 is capable of connecting to a service provider 110, and may include a modem connection, an internet connection, a cable connection, a wireless connection, a satellite connection, or other form of communication as known in the art of data communication. The display device 160 is typically any type of display device commonly utilized with computer systems such as a monitor, a flat-panel display, a touch-sensitive display, or the like. Each of the components of the media selection interface 120 work in concert to facilitate the production of a media hardcopy.

Interaction of the components of the media selection interface 120 are best explained with reference to the following example of an operation of the media selection interface 120 by a user. The media selection interface 120 remains in a dormant state until activated by a user. The dormant state of the media selection interface 120 is similar to a sleep mode of computer as known in the art. Activation of the media selection interface 120 occurs through the selection of an activation switch (not shown) or by user interaction with an input device 122 of the media selection interface 120. Upon activation, a user may interact with and operate the media selection interface 120. In the dormant state, the display device 160 may be blank or it may display advertisements.

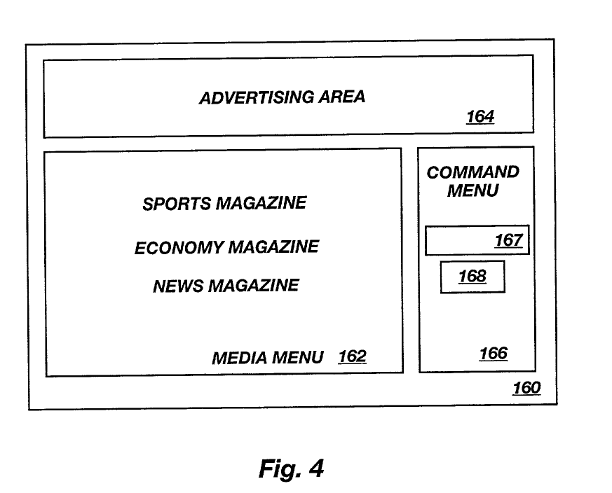

Once activated, the display device 160 displays information for the operation of the media selection interface 120. A typical display device 160 is illustrated in drawing FIG. 4. The illustrated display device 160 includes a media menu 162, an optional advertising area 164, and an optional command menu 166. Displayed within the media menu 162 is a plurality of the media available to the user. Lists of the available magazines, newspapers, journals, stories, or otherwise, are displayed. Lists of the available media are stored in the memory 123 of the media selection interface 120 and displayed in the media menu 162 by the CPU 121. For instance, if the media selection interface 120 is able to obtain and print the magazines “Sports Magazine,” “Economy Magazine,” and “News Magazine,” each of the respective titles is stored in the memory 123 of the media selection interface 120.

In some instances, no user information is necessary to begin a transaction. In one embodiment of the invention, a user is allowed access to the media selection interface 120 without any requirement for identification. For example, a user activates the media selection interface 120, selects a desired media, and inserts the necessary funds required to purchase the selected media. Sufficient funds may be inserted into the media selection interface 120 using vending machine methods such as coin slots, bill acceptors, or credit card magnetic stripe readers, each of which are well known in the art and, therefore, are not explained further herein. Upon receiving sufficient funds, the media selection interface 120 processes the user's order. The selected media, or media request, is passed to a service provider 110. The service provider 110 then connects with the content provider 130 which publishes the media associated with the media request. The content provider 130 sends the service provider 110 an electronic copy of the media request and the service provider 110 passes the electronic file to the media selection interface 120 which then prints and binds the media request for the user.

In other embodiments of the present invention, however, a user is required to log-in to the system so that the specific user may be identified. Numerous log-in methods are available. Users registered with a service provider 110 may be issued a magnetic stripe card to swipe through a magnetic stripe card reader associated with the input device 122 of the media selection interface 120. The media selection interface 120 reads the information from the user's magnetic stripe card and stores it in the memory 123. In this manner the user is identified. Alternatively, a user is prompted to enter an identification code and corresponding password. The media selection interface 120 queries a service provider 110 with the information and compares the identification code and password to user data stored in a user profile database 114. The identity of the user is determined from this information. If the user is properly identified, the service provider 110 communicates verification to the media selection interface 120, allowing the process to continue. If the user is not identified, the service provider 110 queries the media selection interface 120 for user information. An unverified user is prompted by the media selection interface 120 to register with the personalized media service 100 by entering the necessary registration data. Such data may include demographical information and financial information as heretofore discussed.

The registration requirement ensures that the personalized media service 100 is able to obtain demographic information, or other desired information, about the user. This information can then be used to customize and tailor the media selections presented to the user to coincide with the interests of the user. Further, content providers 130 may include additional or bonus materials to the user based upon the user's preferences. The user can also select or reject media involving subjects of particular or no interest to the user. For instance, a user may be interested in media covering sports, especially bicycling, but not necessarily rugby. If that user requests a sports media selection the content provider is informed of the user's preferences for bicycling and lack of enthusiasm for rugby. The content provider 130 tailors the articles provided to fit the user's interests, in this case by providing more articles about bicycling and fewer articles, if any, about rugby.

Registration also allows the user to designate a method of payment to be used for any transactions that are made with the personalized media service 100. The user may select to be billed at a certain billing address on a periodic basis. Alternatively, the user might choose to have the personalized media service 100 debit a credit card for every transaction. The requisite credit card information and authorization for such transfers are provided during the registration process.

Upon activation of a media selection interface 120, the CPU 121 retrieves the titles of the available media from the memory 123 and displays them in the media menu 162. The CPU 121 may also query a service provider 110 for an updated list of available media to store the updated list in memory 123. The media menu 162 may also be customized according to the user's preferences such that the user's favorite media are displayed along with other media to which the user may be interested based upon the known user preferences.

The desired media is selected from the media menu 162 using the input device 122 of the media selection interface 120. Although many different input devices 122 may be utilized, the most common input device 122 is a standard computer keyboard. Using the directional keys of a keyboard, a user selects the desired media from the list in the media menu 162. Depending upon the number of selections available to the user, the keyboard may be used to input a name, phrase, or word to search for in the databank of available media selections. For example, the optional command menu 166 may include a search term input field 167 and search button 168. As the user inputs a search term it is displayed in the search term input field 167. Selecting the search button 168 instructs the CPU 121 to search the memory 123 for any available media titles containing the entered search term. Corresponding available media are displayed in the media menu 162 based upon a completed search. Such search methods are well known in the art and, therefore, will not be explained further.

In another embodiment of the invention, the display device 160 and the input device 122 are combined as a touch screen display (not shown). A user chooses preferences from the display device 160 by physically touching that portion of the screen associated with the desired preference. The use of such touch screen displays is well known and, therefore, will not be explained further herein.

Selection of an available media product from the media menu 162 constitutes a media request. The media selection interface 120 queries a service provider 110 with the media request. Using the remote communications port 125, the media selection interface 120 communicates data to the service provider 110 via the communications port 112. The communicated data is sufficient to inform the service provider 110 of the media request requirements. For example, each of the available media stored in the memory 123 of the media selection interface 120 may also be associated with an identification code stored in the memory 123. The media selection interface 120 retrieves the identification code corresponding to the media request from its memory 123 and transmits the identification code to the service provider 110. The service provider 110 receives the identification code and compares it to a stored database to determine the proper content provider 130 to query to obtain an electronic copy of the media request. The service provider 110 then queries the content provider 130 and retrieves an electronic copy of the media request. The service provider 110 sends the electronic copy of the media request to the media selection interface 120. The media selection interface 120 converts the electronic copy of the media request into a hardcopy. The hardcopy is distributed to the user.

In those embodiments of the personalized media service 100 of the present invention where the user is first required to log-in to the personalized media service 100, the media request may be personalized to the individual user. When a user logs-in to the personalized media service 100, the user's demographic information and user preferences are available in a user profile database 114 stored with the service provider 110. The demographic information and user preferences may be combined with a media request to allow the content provider 130 to customize the electronic copy of the media request sent back to the service provider 110 and the media selection interface 120 for distribution. The user's demographic information may be sent to the content provider 130 in an anonymous manner, such that the identity of the user is undeterminable from the demographic information provided. For example, a user may designate information about bicycling as a preference over other sports articles for any sports media ordered through the personalized media service 100. If the user logs-in to the personalized media service 100 and selects a sports magazine as the requested media, the service provider 110 communicates the preference for bicycling to the content provider 130 along with the media request. The content provider 130, in turn, may acknowledge the preference by including more articles or information about bicycling in the electronic media request copy returned to the service provider 110. The content provider 130 may include multiple targeted articles dealing with the specific interest of the user. In the bicycling example, the targeted articles may include information on the user's preferred brands, trail reviews about areas that the user prefers to ride, or other detailed information such that it appears that the media was written specifically for the user.

Similarly, the content provider 130 could provide a user with “bonus” material based upon a user's preferences. For example, the service provider 110 automatically transmits the user's preferences and demographic information to the content provider 130. The content provider 130 analyzes the user information and includes “bonus” material with the electronic media request copy to the service provider 110. Such “bonus” material may include such things as additional articles corresponding with the user's interests or samples of other media published by the content provider 130 which the user may be interested in based upon the demographic information provided to the content provider 130.

In still another embodiment of the present invention, a user completes a media request using a remote selection interface 140. Typically, the remote selection interface 140 is a computer program or internet connection capable of communicating with a service provider 110 or media selection interface 120. A user logs-in and submits a media request to the personalized media service 100 using the remote selection interface 140 in much the same way that a user would log-in to a media selection interface 120. However, the user must also designate the method of delivery for the media request when using the remote selection interface 140. For instance, an internet connection to a service provider 110 acts as a remote selection interface 140. The user logs-in and makes a media request. The remote selection interface 140 then prompts the user to select the method of delivery for the hardcopy of the media request. The user may choose to pick up the media request at a nearby media selection interface 120, or have a hardcopy of the media request delivered to the user via mail or other delivery system. Once the media request and delivery choice are complete, the service provider 110 processes the media request the same way as a request from a media selection interface 120. If the user chose to pick up the hardcopy of the media request at a nearby media selection interface 120, the service provider 110 sends the electronic media request copy to that media selection interface 120 for printing and binding. If the user requests that the hardcopy of the media request be mailed or delivered, the service provider 110 either sends the electronic media request copy, along with delivery information, to the media selection interface 120 nearest the user for processing, or the service provider 110 prints the media request and initiates the delivery process. In this manner, a user in a remote location, or a user lacking access to a media selection interface 120, may utilize the personalized media service 100 from the comfort of their own home.

Having thus described certain preferred embodiments of the present invention, it is to be understood that the invention defined by the appended claims is not to be limited to particular details set forth in the above description, as many apparent variations thereof are possible without departing form the spirit or scope thereof as hereinafter claimed.

What is claimed is:

1. A personalized media service device for producing media on demand, comprising a media selection interface for receiving a media request from a user and printing a hardcopy of said media request.

2. The personalized media service device of claim 1, wherein said media selection interface comprises:
a memory for storing media data;
a printer device for printing said hardcopy of said media request;
an input device for retrieving information from a user;
a display device for displaying lists of available media selections and input options;
at least one communications port for communicating with a remote device; and
a central processing unit for communicating with said memory, said printer device, said input device, said display device, and said at least one communications port.

3. The personalized media service device of claim 2, further comprising media stored in a data format in said memory for retrieval by said central processing unit and printing by said printer device.

4. The personalized media service device of claim 2, further comprising a service provider for communicating with said central processing unit through said at least one communications port for receiving said information from a user and providing media in a data format to said media selection interface.

5. The personalized media service device of claim 4, wherein said service provider comprises:
a computer for communicating with said central processing unit;
at least one user profile database for storing demographic information about users of said personalized media service device received from said central processing unit; and
at least one database of available media selections and corresponding media selection retrieval information for providing media in said data format to said central processing unit.

6. The personalized media service device of claim 5, wherein said stored demographic information about a user in said user profile database is information selected from the group consisting of gender, age, hobbies, interests, income, profession, education, marital status, vehicles owned, sports played, consumer goods owned, services used, and user preferences.

7. The personalized media service device of claim 4, further comprising at least one content provider in communication with said service provider for providing media in said data format to said service provider in response to said retrieved information.

8. The personalized media service device of claim 7, wherein said at least one content provider comprises a media publisher computer for storing and transmitting said media in said data format to said service provider.

9. The personalized media service device of claim 2, further comprising an authentication device for communicating with said central processing unit for identifying a user of said personalized media service.

10. A method of creating a hardcopy media selection for a user, comprising:
providing the user a menu of available media selections for choosing a desired media selection for creation;
identifying a media selection made by the user;
retrieving a data format copy of said media selection; and
printing a hardcopy of said media selection from said data format copy of said media selection.

11. The method of claim 10, wherein said providing the user a menu of available media selections for choosing a desired media selection for creation comprises:
providing a user interface having a touch screen display; and
displaying said menu of available media selections on said touch screen display.

12. The method of claim 10, wherein said providing the user a menu of available media selections for choosing a desired media selection for creation comprises:
providing a user interface comprising a display device and an input device;
displaying a search field on said display device for displaying a search phrase entered by said user with said input device;
displaying a search button on said display device for activation by said user with said input device;
detecting activation of said search button;
creating a customized list of available media selections from said menu of available media selections based upon said search phrase upon activation of said search button; and
displaying said customized list of available media selections on said display device.

13. The method of claim 10, wherein said providing the user a menu of available media selections for choosing a desired media selection for creation comprises:
establishing a connection between a computer and a service provider using the internet;
linking said computer to a menu page stored in a memory of said service provider;
retrieving a list of available media selections from said memory of said service provider;
displaying said list of available media selections on said menu page linked to said computer; and
prompting said user to choose one of said available media selections.

14. A method of creating a hardcopy of a media selection made by a user, comprising:
providing a media selection interface including a central processing unit, a display device for displaying available media selections to the user, a memory, an input device, a printer device, and at least one communications port;
retrieving a list of available media selections from said memory of said media selection interface;
displaying at least a portion of said available media selections on said display device of said media selection interface;
prompting said user to use said input device to input a media request from said displayed available media selections;
obtaining said media request from said user; communicating said media request to a service provider using said at least one communications port;
determining a content provider to query for an electronic copy of media associated with said media request from a database accessible to said service provider;
querying said determined content provider for said electronic copy of media associated with said media request; and
communicating said electronic copy of media associated with said media request to said central processing unit of said media selection interface using said service provider and said at least one communications port.

15. The method of claim 14, further comprising printing a hardcopy of said electronic copy of media associated with said media request on said printer device of said media selection interface.

16. The method of claim 14, wherein said retrieving a list of available media selections from said memory of said media selection interface comprises:
retrieving a list of newspapers available to said media selection interface from said service provider; and
retrieving a list of magazines available to said media selection interface from said service provider.

17. The method of claim 14, further comprising:
displaying the total cost of said media request on said display device of said media selection interface;
prompting said user to make a payment for said media request; and
verifying payment of said payment for said media request before communicating said media request to said service provider.

18. The method of claim 14, further comprising identifying said user before retrieving a list of available media selections.

19. The method of claim 18, further comprising debiting a user's account for the cost of said media request following said printing of said hardcopy of said media request.

20. The method of claim 18, wherein said querying said determined content provider for an electronic copy of said media selection comprises:
retrieving a set of user preferences corresponding to said user identity from a user profile database;
querying said determined content provider for said electronic copy of media associated with said media request;
including said set of user preferences with said query; and
creating a customized electronic copy of media associated with said media request based upon said set of user preferences.

21. The method of claim 18, wherein said identifying said user comprises:
displaying a user log-in request on said display device of said media selection interface;
prompting said user to enter log-in information using said input device of said media selection interface;
communicating said log-in information to said service provider using said at least one communications port;
comparing said log-in information to at least one user profile database accessible to said service provider to determine an identity of said user;
authorizing use of the media selection interface when said identity of said user is determined; and
prompting said user to register a user profile in said user profile database if said identity of said user is not determined and authorizing use of the media selection interface following completion of said registration of said user profile.

22. The method of claim 14, further comprising:
identifying said user before retrieving a list of available media selections; and
retrieving a list of user preferences corresponding to said user identity from a user profile data base accessible to said service provider and storing said user preferences in said memory of said media selection interface.

23. The method of claim 22, wherein said displaying at least a portion of said available media selections on said display device of said media selection interface comprises:
comparing said list of available media selections to said user preferences retrieved from said user profile database;
creating a customized list of available media selections based upon said user preferences; and
displaying at least a portion of siad customized list of available media selections on said display device of said media selection interface.
